(19) United States
(12) Patent Application Publication
(10) Pub. No.: US 2025/0298615 A1
(43) Pub. Date: Sep. 25, 2025

(54) Parsing FPGA Counter Data Records in Network Devices with FPGAs

(71) Applicant: Arista Networks, Inc., Santa Clara, CA (US)

(72) Inventors: Diego Alfredo ASTURIAS, Mountain View, CA (US); Alon PEKUROVSKY, Sacramento, CA (US); Alejandro Javier SCHWOYKOSKI, Sydney (AU); Thomas DEJANOVIC, Sydney (AU); Nicholas JOUKHDAR, Sydney (AU); Callum HUNTER, Sydney (AU)

(21) Appl. No.: 18/613,787

(22) Filed: Mar. 22, 2024

(51) Int. Cl. G06F 9/30; G06F 9/32

(52) U.S. Cl. CPC G06F 9/3013; G06F 9/321

(57) ABSTRACT

Techniques for parsing FPGA counter data records in a network device with an FPGA are provided. In one set of embodiments these techniques include ingesting, by the network device, a metadata file associated with an application image programmed in (or configured to be programmed in) the FPGA, where the metadata file includes definitions of counter data record types that are used (i.e., reported via counter messages) by the application image. The techniques further include receiving a counter message from the FPGA that includes one or more counter data records and, for each record, retrieving the ingested definition of that record's type and parsing the record in accordance with the definition.

### BACKGROUND

Network devices such as switches and routers include a data plane that handles the physical movement of network packets through the device. In some network devices this data plane is implemented using a field-programmable gate array (FPGA), which is a type of integrated circuit that can be re-programmed with different circuit designs, known as application images, to perform different tasks.

Application images that are created for programming into a network device's FPGA often track counters pertaining to the data plane traffic handled by the FPGA and report data records for these counters to an operating system (OS) of the network device via periodic messages, referred to as counter messages. Upon receiving a counter message, the OS parses the counter data records included therein and stores the results.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example environment in accordance with certain embodiments of the present disclosure.

FIG. 2 depicts a modified version of the environment of FIG. 1 in accordance with certain embodiments of the present disclosure.

FIG. 3 depicts a counter metadata generation workflow in accordance with certain embodiments of the present disclosure.

FIG. 4 depicts a counter metadata ingestion workflow in accordance with certain embodiments of the present disclosure.

FIG. 5 depicts a counter data record parsing workflow in accordance with certain embodiments of the present disclosure.

FIG. 6 depicts an example computer system in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for parsing FPGA counter data records in a network device with an FPGA. In one set of embodiments these techniques include ingesting, by the network device, a metadata file associated with an application image programmed in (or configured to be programmed in) the FPGA, where the metadata file includes definitions of counter data record types that are used (i.e., reported via counter messages) by the application image. The techniques further include receiving a counter message from the FPGA that includes one or more counter data records and, for each record, retrieving the ingested definition of that record's type and parsing the record in accordance with the definition.

### 1. Example Environment and Solution Overview

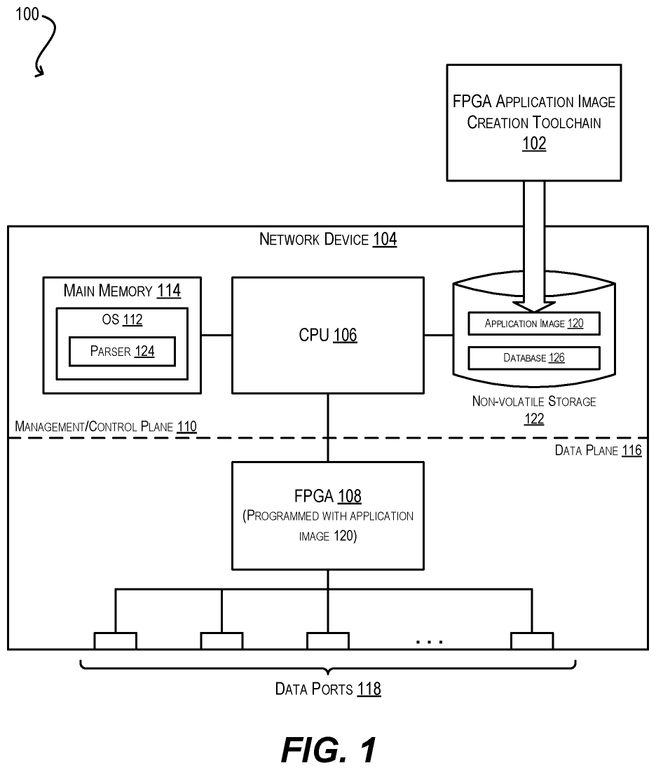

FIG. 1 is a simplified block diagram of an example environment 100 in which the techniques of the present disclosure may be implemented. As shown, environment 100 includes an FPGA application image creation toolchain 102 and a network device 104 comprising, among other things, a central processing unit (CPU) 106 and an FPGA 108. Network device 104 may be, e.g., a switch, a router, or any other type of device operable for transmitting and/or processing network packets in a computer network.

CPU 106 implements the management/control plane of network device 104 (shown via reference numeral 110) and thus is generally responsible for managing the configuration of network device 104 and controlling the device's understanding of the network in which it resides. CPU 106 carries out these functions under the direction of an OS 112 that runs on the CPU from a main memory (e.g., random-access memory (RAM)) 114.

FPGA 108 implements the data plane of network device 104 (shown via reference numeral 116) and thus is generally responsible for processing network packets that pass through the device via a set of ports 118. As mentioned previously, an FPGA is a type of integrated circuit that can be re-programmed with different application images, where each application image defines how the FPGA's internal logic elements (e.g., logic blocks and interconnects) should be configured. Through this re-programmability, an FPGA can be adapted to perform a variety of tasks. This is in contrast to an application-specific integrated circuit (ASIC), which is a type of integrated circuit whose internal logic elements are hardwired to perform a particular set of tasks.

In the example of FIG. 1, FPGA 108 is programmed with an application image 120 that is created using FPGA application image creation toolchain 102 (hereinafter simply “toolchain 102”) and is maintained in a non-volatile storage 122 of network device 104. Toolchain 102, which consists of a series of software tools for designing, synthesizing, and testing FPGA application images, typically runs on one or more computer systems that are separate from network device 104. This toolchain may be operated by the manufacturer of network device 104, a device customer, or any other entity with an interest in creating such images for network device 104.

By being programmed into FPGA 108, application image 120 enables the FPGA to carry out data plane functions in accordance with the image's design. For example, if application image 120 is designed to provide Layer 2 (L2) forwarding functionality, image 120 can enable FPGA 108 to receive an inbound packet on an ingress port 118; extract the packet's L2 (e.g., Ethernet) header; determine, based on the L2 header and a forwarding information base (FIB) populated by CPU 106, an egress port to which the packet should be sent in order to reach its intended destination; and forward the packet to the determined egress port 118. As another example, if application image 120 is designed to provide Layer 1 (L1) switching functionality, image 120 can enable FPGA 108 to receive an inbound packet on an ingress port 118 and forward the packet to an egress port 118 that is directly mapped to the ingress port.

As noted in the Background section, application images like image 120 that are programmed into a network device's FPGA often track counters pertaining to the data plane traffic handled by the FPGA and report (or in other words, output) data records for the counters to the network device's OS via periodic counter messages. Upon receiving a counter message, the OS parses the counter data records contained therein and saves the parsed data for various purposes (e.g., diagnostics, monitoring, etc.). For example, in FIG. 1, OS 112 of network device 104 includes a parser 124 that parses the content of counter messages output by FPGA 108 (per its programmed application image 120) and stores the results in a database 126 held in non-volatile storage 122.

One issue with existing implementations of parser 124 is that they typically hard-code counter-specific logic for parsing the various types of counter data records they may receive. For example, if application image 120 is designed to report three types of counter data records T1, T2, and T3, a conventional implementation of parser 124 will include a first code section that is specifically designed to parse counter data records of type T1, a second code section that is specifically designed to parse counter data records of type T2, and a third code section that is specifically designed to parse counter data records of type T3. This approach is problematic because FPGA 108 can be re-programmed with other application images (and/or with updated version(s) of application image 120) that employ new types of counters, and thus output new types of counter data records. In such scenarios, a new version of parser 124 that is capable of parsing those new counter data record types must be developed, compiled, and installed on network device 104, which is a time-consuming and burdensome endeavor.

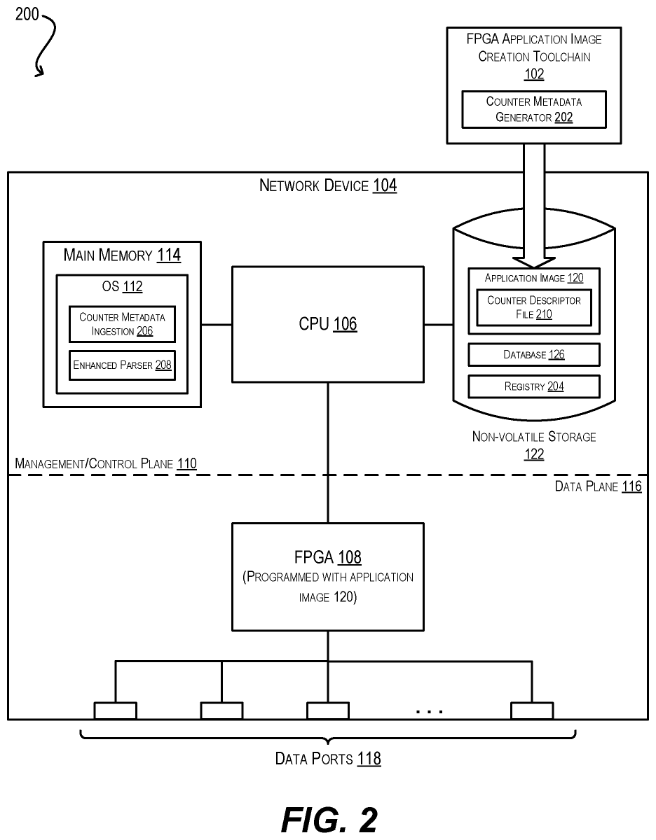

To address this issue, FIG. 2 depicts a modified version 200 of environment 100 of FIG. 1 that implements a metadata-driven framework for parsing counter data records reported by FPGA 108 of network device 104 according to certain embodiments. This framework includes a counter metadata generator 202 in toolchain 102, a registry 204 in non-volatile storage 122 of network device 104, and a counter metadata ingestion component 206 and an enhanced parser 208 in OS 112 in network device 104. Framework components 202-208 may be implemented in software, in hardware, or a combination thereof.

Generally speaking, counter metadata generator 202 is configured to generate, as part of the process of creating an application image via toolchain 102, a metadata file (referred to as a counter descriptor file) that includes definitions of the various types of counter data records output by that application image. For instance, as shown in FIG. 2, counter metadata generator 202 has generated a counter descriptor file 210 that is associated with application image 120 and is embedded in image 120.

Each counter data record type definition included in the counter descriptor file comprises metadata usable for recognizing and parsing counter data records of that type which are output by the associated application image. By way of example, in certain embodiments each application image created via toolchain 102 can be designed to output counter data records according to a predefined TLV (type/length/value) format, such that each counter data record includes a fixed-length type field indicating the type of that record, a variable-length value field comprising the payload of the record, and a fixed-length length field indicating the length (e.g., in bits or bytes) of the value field. In these embodiments, the counter descriptor file associated with a given application image can include counter data record type definitions that enable parsing of the variable-length value fields of the counter data records output by the image.

Counter metadata ingestion component 206 (hereinafter simply “ingestion component 206”) is configured to receive the counter descriptor files generated by counter metadata generator 202 and ingest the files into registry 206, thereby populating the registry with entries corresponding to the files' counter data record type definitions. In certain embodiments, ingestion component 206 can ingest a given counter descriptor file at the time OS 112 installs that file's associated application image on network device 104, or in other words at the time OS 112 persists the application image on non-volatile storage 122 and configures itself to program image into FPGA 108.

Finally, enhanced parser 208 is configured to receive, during the runtime of network device 104, counter messages from FPGA 108 that comprise counter data records corresponding to the record types used by the application image programmed into the FPGA (i.e., application image 120 in FIG. 2), and for each counter data record, retrieve an entry from registry 204 that matches the record's type and parse the counter data record in accordance with the definition included in the retrieved entry. Because the parsing performed by enhanced parser 208 is driven by the counter data record type definitions held in registry 204, the parser can implement generic parsing logic that works for any counter data record which conforms to its corresponding type definition, rather than hard-coded, counter-specific parsing logic that is targeted to individual counter data record types. Accordingly, the framework shown in FIG. 2 advantageously avoids the need for parser 208 to be updated each time FPGA 108 is re-programmed with an application image that introduces new counter types, thereby streamlining the process of deploying such application images.

The remaining sections of this disclosure provide additional details regarding the operation of counter metadata generator 202, ingestion component 206, and enhanced parser 208 according to certain embodiments. It should be appreciated that FIGS. 1 and 2 are illustrative and not intended to limit embodiments of the present disclosure. For example, although FIG. 2 depicts components 204-208 as being implemented on network device 104, in some embodiments one or more of these components may be implemented at another location. For example, in a particular embodiment enhanced parser 208 may be implemented on a centralized server or set of servers that is communicatively coupled with network device 104 and other similar network devices. In this scenario, each network device can forward its counter messages to the server for processing by enhanced parser 208.

Further, although FIGS. 1 and 2 depict data plane 116 of network device 104 as being implemented using a single FPGA 108, in some embodiments data plane 116 may be implemented using multiple FPGAs, each connected to a different subset of ports 118 and connected to each other via a data fabric/backplane. In these embodiments, ingestion component 206 can ingest multiple counter descriptor files associated with the application images programmed into the multiple FPGAs and enhanced parser 208 can parse counter data records received from the multiple FPGAs using an appropriate subset of registry entries. For example, if enhanced parser 208 receives a first counter message from a first FPGA F1 programmed with an application image A1 and a second counter message from a second FPGA F2 programmed with an application image A2, the parser can parse the counter data records in the first counter message using registry entries that are mapped to image A1/F1 and can parse the counter data records in the second counter message using registry entries that mapped to image A2/F2.

### 2. Counter Metadata Generation

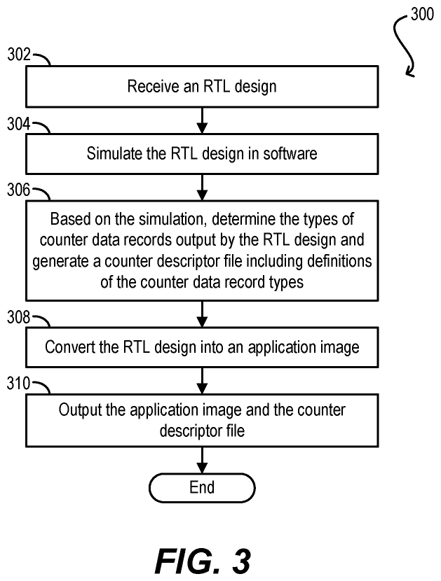

FIG. 3 depicts a workflow 300 that may be performed by toolchain 102 and counter metadata generator 202 for creating an application image (e.g., image 120) and its associated counter descriptor file (e.g., file 210) according to certain embodiments.

Starting with step 302, toolchain 102 can receive from, e.g., one or more human design engineers, a register transfer level (RTL) design for an application image that describes the desired behavior and structure of the FPGA on which the image will be programmed. This RTL design is typically specified in a hardware description language (HDL) such as VHDL or Verilog.

At step 304, toolchain 102 can simulate the RTL design in software. Based on this simulation, counter metadata generator 202 can determine the types of counter data records output by the RTL design and can generate a counter descriptor file comprising definitions of the record types (step 306). For example, as indicated previously, in some embodiments the counter data records output by the RTL design can conform to a predefined TLV format. In these embodiments, the definition of each counter data record type T included in the counter descriptor file generated at step 306 can include an identifier (ID) of type T (as found in the counter data record type field) and a set of sub-fields found in the value field. Examples of these sub-fields include, e.g., the name of the counter to which the counter data record pertains, a short description of the counter, the current value of the counter, an ID of a physical FPGA interface associated with the counter, and so on. In a particular embodiment, the sub-fields may be presented as an ordered list in the counter data record type definition, thereby indicating the order in which those sub-fields will appear in the value field of counter data records of that type.

At step 308, toolchain 102 can convert the RTL design into an application image and can optionally embed the generated counter descriptor file into the image. Finally, toolchain 102 can output the application image with the (embedded or non-embedded) counter descriptor file (step 310) and workflow 300 can end.

### 3. Counter Metadata Ingestion

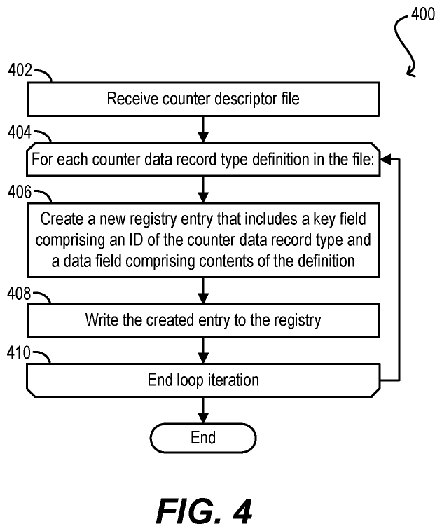

FIG. 4 depicts a workflow 400 that may be performed by ingestion component 206 of network device 104 for ingesting a counter descriptor file generated via workflow 300 of FIG. 3 according to certain embodiments. This counter descriptor file is assumed to be associated with an application image that is (or will be) programmed into FPGA 108 of network device 104, such as application image 120 shown in FIGS. 1 and 2. As mentioned previously, workflow 400 can be performed at the time the application image is installed on the network device.

Starting with steps 402 and 404, ingestion component 206 can receive the counter descriptor file and enter a loop for each counter data record type definition included in the file. Within this loop, ingestion component 206 can create a new registry entry that includes a key field comprising an ID of the counter data record type the definition pertains to and a data field comprising the contents of the definition (step 406). In certain embodiments, the key field may also comprise an ID of the application image associated with the counter descriptor file. Ingestion component 206 can then write the created registry entry to registry 204 (step 408).

At step 410, ingestion component 206 can reach the end of the current loop iteration and return to the top of the loop to process the next counter record type definition. Upon processing all such definitions in the counter descriptor file, workflow 400 can end.

### 4. Counter Data Record Parsing

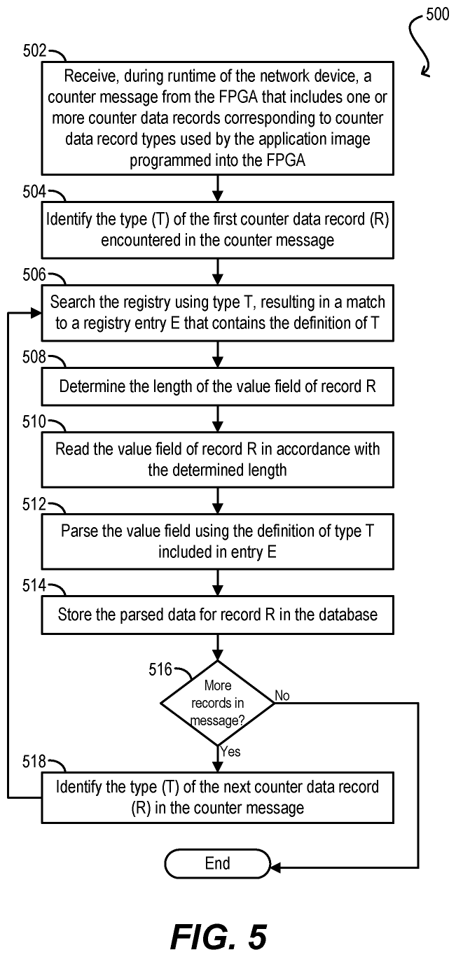

FIG. 5 depicts a workflow 500 that may be performed by enhanced parser 208 of network device 104 for parsing counter data records that are received from FPGA 108 according to certain embodiments. Workflow 500 assumes that FPGA 108 is programmed with an application image whose associated counter descriptor file has been ingested into registry 204 per workflow 400 of FIG. 4. Workflow 500 further assumes that the received counter data records are formatted using a TLV format comprising a type field with a fixed length (e.g., 16 bits), a length field with a fixed length (e.g., 16 bits), and a value field with a variable length (as defined in the length field).

Starting with step 502, enhanced parser 208 can receive, during the runtime of network device 104, a counter message from FPGA 108 that includes one or more counter data records corresponding to the counter data record types used by the application image programmed into the FPGA (e.g., image 120). In one set of embodiments, this counter message may take the form of a network packet, such as a User Datagram Protocol (UDP) packet.

At step 504, enhanced parser 208 can identify the type (T) of the first counter data record (R) encountered in the counter message, as indicated in the record's type field. Enhanced parser 208 can then search registry 204 using counter data record type T (and optionally the ID of the application image), resulting in a match to a registry entry E that contains the definition of T (step 506). Although not shown in the figure, in certain embodiments enhanced parser 208 can determine the ID of the application image (if needed) by querying another OS component that is configured to keep track of the application images programmed into the FPGA(s) of network device 104.

Upon finding matching registry entry E, enhanced parser 208 can determine the length of the value field of counter data record R from the record's predefined length field (step 508), read the value field from the counter message in accordance with the determined length (510), and parse the value field using the counter data record type definition included in E (step 512). For example, assume the value field is 128 bits long and the definition in registry entry E indicates that it is composed of a “counter name” sub-field covering the first 96 bits and a “counter value” field covering the last 32 bits. In this scenario, enhanced parser 208 can read, from the counter message, the 128 bits following the type and length fields of counter data record R (which correspond to R's value field) and can interpret the first 96 bits of this data as the counter name and interpret the last 32 bits of this data as the counter value.

At step 514, enhanced parser 208 can store the parsed data for counter data record R in database 126. In some cases, the parsed data can include an ID of a physical interface of FPGA 108 to which record R pertains, where the physical FPGA interface maps to a functional/virtual interface of network device 104. In these cases, enhanced parser 208 can translate the ID of the physical FPGA interface into the ID of its corresponding functional/virtual interface and can store this functional/virtual interface ID, with the parsed data for record R, in database 126.

Finally, at step 516, enhanced parser 208 can check whether there are any further counter data records in the counter message. If the answer is yes, enhanced parser 208 can identify the type (T) of the next counter data record (R) (step 518) and can return to step 506. Otherwise, workflow 500 can end.

### 5. Example Computer System

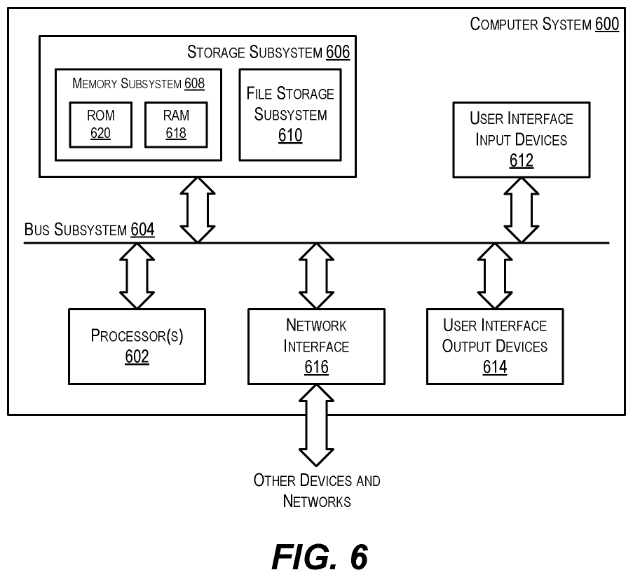

FIG. 6 depicts an example computer system 600 according to certain embodiments of the present disclosure. Computer system 600 (or a cluster of such systems) may be used to run some or all of the components of the framework described herein, including counter metadata generator 202 and enhanced parser 208.

As shown in FIG. 6, computer system 600 includes one or more CPUs 602 that communicate with a number of peripheral devices via a bus subsystem 604. These peripheral devices include a storage subsystem 606 (comprising a memory subsystem 608 and a file storage subsystem 610), user interface input devices 612, user interface output devices 614, and a network interface subsystem 616.

Bus subsystem 604 provides a mechanism for letting the various components and subsystems of computer system 600 communicate with each other as intended. Although bus subsystem 604 is shown schematically as a single bus, alternative embodiments of the bus subsystem can utilize multiple buses.

Network interface subsystem 616 serves as an interface for communicating data between computer system 600 and other computing devices or networks. Embodiments of network interface subsystem 616 can include wired (e.g., coaxial, twisted pair, or fiber optic) and/or wireless (e.g., Wi-Fi, cellular, Bluetooth, etc.) interfaces.

User interface input devices 612 can include a keyboard, pointing devices (e.g., mouse, trackball, touchpad, etc.), a scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 600.

User interface output devices 614 can include a display subsystem such as a flat-panel display or non-visual displays such as audio output devices, etc. In general, use of the term “output device” is intended to include all possible types of devices and mechanisms for outputting information from computer system 600.

Storage subsystem 606 includes a memory subsystem 608 and a file/disk storage subsystem 610. Subsystems 608 and 610 represent non-transitory computer-readable storage media that can store, in a non-transitory state, program code and/or data that provide the functionality of various embodiments described herein.

Memory subsystem 608 includes a number of memories including a main random-access memory (RAM) 618 for storage of instructions and data during program execution and a read-only memory (ROM) 620 in which fixed instructions may be stored. File storage subsystem 610 can provide persistent (i.e., non-volatile) storage for program and data files and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 600 is illustrative and many other configurations having more or fewer components than computer system 600 are possible.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device including a field-programmable gate array (FPGA), the FPGA being programmed with an application image, the method comprising:
ingesting definitions of one or more counter data record types used by the application image;
receiving, from the FPGA, a counter message that includes one or more counter data records corresponding to the one or more counter data record types; and
for each counter data record in the counter message:
retrieving the ingested definition of the counter data record type corresponding to the counter data record; and
parsing the counter data record using the ingested definition.

2. The method of claim 1 further comprising:
storing a result of the parsing in a database of the network device.

3. The method of claim 1 wherein the ingesting comprises:
receiving a metadata file including the definitions of the one or more counter data record types, the metadata file being associated with the application image; and
ingesting the metadata file into a registry of the network device.

4. The method of claim 3 wherein ingesting the metadata file into the registry comprises, for each definition of a counter data record type included in the metadata file:
creating a registry entry that includes a key field comprising an identifier of the counter data record type and a value field comprising contents of the definition; and
storing the registry entry in the registry.

5. The method of claim 3 wherein the metadata file is generated at a time of creating the application image.

6. The method of claim 3 wherein the metadata file is generated by an FPGA application image creation toolchain that creates the application image.

7. The method of claim 1 wherein the ingesting is performed at a time of installing the application image on the network device.

8. The method of claim 1 wherein the ingested definition of the counter data record type includes:
an identifier of the counter data record type; and
a list of sub-fields that appear in a value field of counter data records corresponding to the counter data record type.

9. The method of claim 8 wherein retrieving the ingested definition of the counter data record type corresponding to the counter data record comprises:
matching a type identifier found in a type field of the counter data record to the identifier of the counter data record type included in the ingested definition.

10. The method of claim 8 wherein parsing the counter data record using the ingested definition comprises:
parsing data found in a value field of the counter data record using a list of sub-fields included in the ingested definition.

11. The method of claim 8 wherein the one or more sub-fields include a counter name sub-field and a counter value sub-field.

12. The method of claim 8 wherein the one or more sub-fields include a sub-field indicating an identifier of a physical interface of the FPGA.

13. A network device comprising:
a central processing unit (CPU);
a field-programming gate array (FPGA) implementing a data plane of the network device, the FPGA being programmed with an application image; and
an operating system (OS) running on the CPU that is configured to:
ingest definitions of one or more counter data record types used by the application image;
receive, from the FPGA, a counter message that includes one or more counter data records corresponding to the one or more counter data record types; and
for each counter data record in the counter message:
retrieve the ingested definition of the counter data record type corresponding to the counter data record; and
parse the counter data record using the ingested definition.

14. The network device of claim 13 wherein the ingested definition of the counter data record type includes:
an identifier of the application image;
an identifier of the counter data record type; and
a list of sub-fields that appear in a value field of counter data records corresponding to the counter data record type.

15. The network device of claim 14 wherein retrieving the ingested definition of the counter data record type corresponding to the counter data record comprises:
determining an identifier of the application image;
matching the determined identifier of the application image to the identifier of the application image included in the ingested definition; and
matching a type identifier found in a type field of the counter data record to the identifier of the counter data record type included in the ingested definition.

16. The network device of claim 15 wherein determining the identifier of the application image comprises:
providing an identifier of the FPGA to a component of the OS; and
receiving the identifier of the application image from the component in response to the providing.

17. The network device of claim 13 wherein parsing the counter data record comprises:
determining an identifier of a physical interface of the FPGA to which the counter data record pertains.

18. The network device of claim 17 wherein the OS is further configured to:
translate the identifier of the physical interface of the FPGA into an identifier of a functional or virtual interface of the network device; and
store the identifier of the functional or virtual interface with a result of the parsing in a database of the network device.

19. A method comprising:
receiving a counter message output by a field-programmable gate array (FPGA) of a network device, wherein the FPGA is programmed with an application image, and wherein the counter message includes one or more counter data records corresponding to one or more counter data record types used by the application image; and
for each counter data record in the counter message:
retrieving metadata for a counter data record type corresponding to the counter data record; and
parsing the counter data record using the retrieved metadata.

20. The method of claim 19 wherein the method is performed by a computer system distinct from the network device.
